(19) United States
(12) Patent Application Publication
(10) Pub. No.: US 2006/0100924 A1
(43) Pub. Date: May 11, 2006

(54) Digital media file with embedded sales/marketing information

(75) Inventor: Avadis Tevanian JR., Los Altos Hills, CA (US)

Correspondence Address: BEYER WEAVER & THOMAS LLP, P.O. BOX 70250, OAKLAND, CA, 94612-0250, US

(73) Assignee: Apple Computer, Inc.

(21) Appl. No.: 10/982,592

(22) Filed: Nov. 5, 2004

(51) Int. Cl. G06Q 30/00

(52) U.S. Cl. 705/14

(57) ABSTRACT

Techniques for facilitating e-commerce by utilizing sales, marketing and/or tracking information (“e-commerce information”) embedded in digital media files are disclosed. These techniques can allow a user of a media management application to purchase digital media files or other subject matter based on the embedded e-commerce information.

### BACKGROUND OF THE INVENTION

1. Field of the Invention

The present invention relates to digital media file formats and, more specifically, to sales and marketing information embedded in digital media files.

2. Description of the Related Art

Currently, online media services such as Apple Computer's iTunes™ Music Store, RealNetwork's Rhapsody™, MusicMatch's On Demand™, or Yahoo's Launchcast™ control consumer access to media content by various methods, including by streaming media (but not downloading) to a networked media player or by using copy protection schemes which limit the consumer's ability to redistribute downloaded digital media files. For instance, Rhapsody™ allows unlimited media streaming and allows consumers to burn CDs (but prevents media files from being stored on a hard drive). A second type of access control is used by iTunes™, where files are protected using FairPlay™ Digital Rights Management (DRM) encoding, which prevents the playback of purchased media files on unauthorized media players.

While many consumers are content with streaming media, some prefer to have direct access to media files, enabling them to access the files in situations where there is no access to streaming media. Thus, digital media files have become very popular, and the entertainment industry is constantly searching for new ways to market and sell media content to an increasingly sophisticated audience.

Typically, when a music or other digital media file is created, the file contains both media content as well as information associated with the media content. This information is typically stored in the digital media file's header section. The information may include, for example, copyright information and digital rights management information, as well as descriptive information including title, author, and publisher.

However, current digital media file formats are limited by what types of information can be stored in the file headers, thus restricting marketing methods and distribution options. For example, a music promoter may want to upload a low-quality digital music file of a popular recording artist's hit song without DRM restrictions to a file-sharing service or promotional web site for advertising purposes. Unfortunately, if the distributor wants a recipient of the file (e.g., downloader) to subsequently buy a higher quality file or to buy tickets to a concert by that recording artist, there is conventionally no convenient and quick way to direct the downloader to the distribution/sales point of the distributor's choice. Also, there is no simple way for the distributor to track the file once it has been downloaded. From a marketing perspective, it would be very useful to be able to know where the downloader of an unprotected file obtained the file in order to judge which methods of distribution are most effective.

Currently, many enhanced CDs and DVDs contain hyperlinks to additional media content, often stored on web sites. Further, the process of accessing one or more hyperlinks through a media application, such as Apple Computer's Apple's Quicktime™, is known. However, there has previously been no conventional way to integrate advertising, sales, marketing, and distribution of digital media files.

Thus, there is a need for techniques to encode sales/marketing information and/or tracking data into digital media files in order to improve the process of distribution, marketing, and/or sales of digital media files, as well as related items, such as merchandise or event tickets.

### SUMMARY OF THE INVENTION

The invention pertains to techniques for facilitating e-commerce by utilizing sales, marketing and/or tracking information (“e-commerce information”) that has been embedded in a digital media file. These techniques can allow a user of a media management application to purchase digital media files or other subject matter based on the embedded e-commerce, information.

The invention can be implemented in numerous ways, including as a method, system, device, apparatus, graphical user interface, or computer readable medium. Several embodiments of the invention are discussed below.

In one embodiment of the invention, e-commerce information is embedded into a digital media file, typically in the digital media file's header. The embedded information is accessible to a media management application, which, in turn, allows a user to purchase the subject matter of the e-commerce information. The subject matter can be electronic media such as music or video files, event tickets, or even merchandise. In a first example, a low-quality music preview file contains embedded e-commerce information that enables a user who plays the music preview file to purchase a high-quality version of the music preview file. In a second example, a movie trailer file contains embedded e-commerce information that enables a user who plays the file to purchase tickets to an upcoming movie.

In another embodiment of the invention, a digital media file with embedded e-commerce information is obtained (e.g., by downloading or by copying from a file storage device). Next, a user employs a media management application to access the embedded e-commerce information in the digital media file. Finally, the user directs the media management application to purchase one or more rights associated with the digital media file. These rights include, but are not limited to, the right to play the digital media file on a media player, and the right to copy the digital media file onto removable storage media. In one embodiment, a user who has downloaded a digital media file which may not be burned to a CD uses a media management application to purchase the right to burn the file to a CD based on sales data embedded in the digital media file.

In still another embodiment of the invention, a client request to purchase the subject matter of e-commerce information embedded in a digital media file is received. The request is then authenticated, and a payment for the subject matter of the e-commerce information is processed and verified. After verification, the subject matter of the e-commerce information is sent to the requesting client.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a digital media file format according to one embodiment of the invention.

FIG. 2A is an e-commerce system for media items according to one embodiment of the invention.

FIG. 2B is a block diagram of a generic application window according to one embodiment of the invention.

FIG. 3 is a flow diagram of a client-side process for facilitating e-commerce according to one embodiment of the invention.

FIG. 4 is a flow diagram of a media item purchase process according to one embodiment of the invention.

FIG. 5 is a flow diagram of a media item display process according to one embodiment of the invention.

FIG. 6 is a flow diagram of a media purchase process according to one embodiment of the invention.

FIG. 7 is a flow diagram of a media tracking process according to one embodiment of the invention.

FIG. 8 is a flow diagram of a media unlocking process according to one embodiment of the invention.

### DETAILED DESCRIPTION OF THE INVENTION

The invention pertains to techniques for facilitating e-commerce by utilizing e-commerce and/or tracking information that has been embedded in a digital media file. These techniques can allow a user of a media management application (MMA) to purchase digital media files or other associated subject matter based on the embedded e-commerce information.

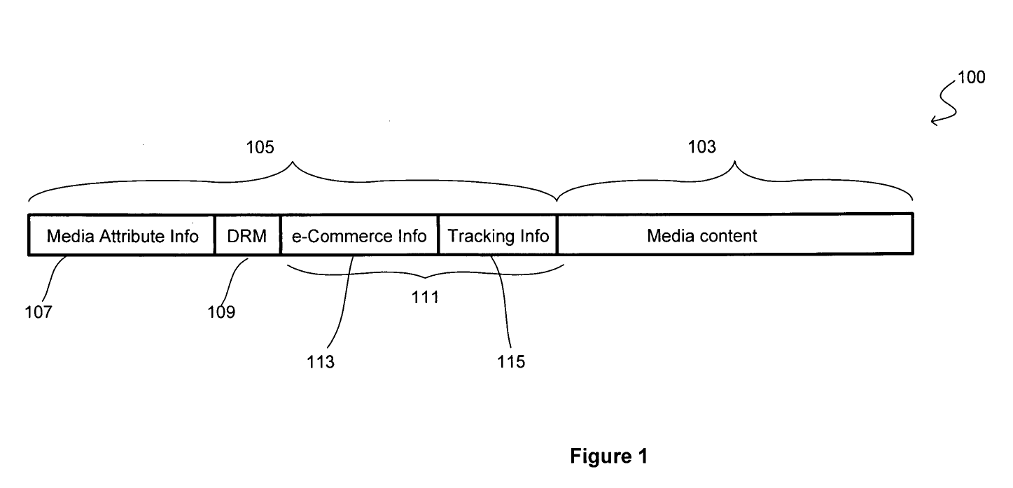

Embodiments of the invention are discussed below with reference to FIGS. 1-8. However, those skilled in the art will readily appreciate that the detailed description given herein with respect to these figures is for explanatory purposes as the invention extends beyond these limited embodiments.

FIG. 1 is a block diagram of a digital media file 100 according to one embodiment of the invention. E-commerce information, including, for example, sales, marketing, or tracking data, can be embedded anywhere in the digital media file. However, the e-commerce information will typically be embedded in a header portion of the digital media file, where other information is commonly stored. More particularly, as shown in FIG. 1, the digital media file 100 consists of a media portion 103 and a header portion 105. The media portion 103 contains media content, such as music or video data. The media content can be in a variety of digital media formats, such as MP3, AAC, WMA, etc. The media content may be encrypted or similarly obfuscated for content control, for example by any of a variety of DRM protocols. The header portion 105 can contain a variety of media attribute information 107, such as artist/author information, that is typically dependent on the media content in the media portion 103. MP3 files, for instance, use a 128-bit ID3 tag with title, album, artist, year, genre, and comment fields. The header portion 105 can also contain digital rights management (DRM) information 109 such as, for example, license keys that allow a user to access media content in media portion 103. The header portion 105 also contains an e-commerce header segment 111. The e-commerce header segment 111 can include e-commerce information 113 and/or tracking information 115. It is understood that FIG. 1 is exemplary, and that various other digital media file formats are possible.

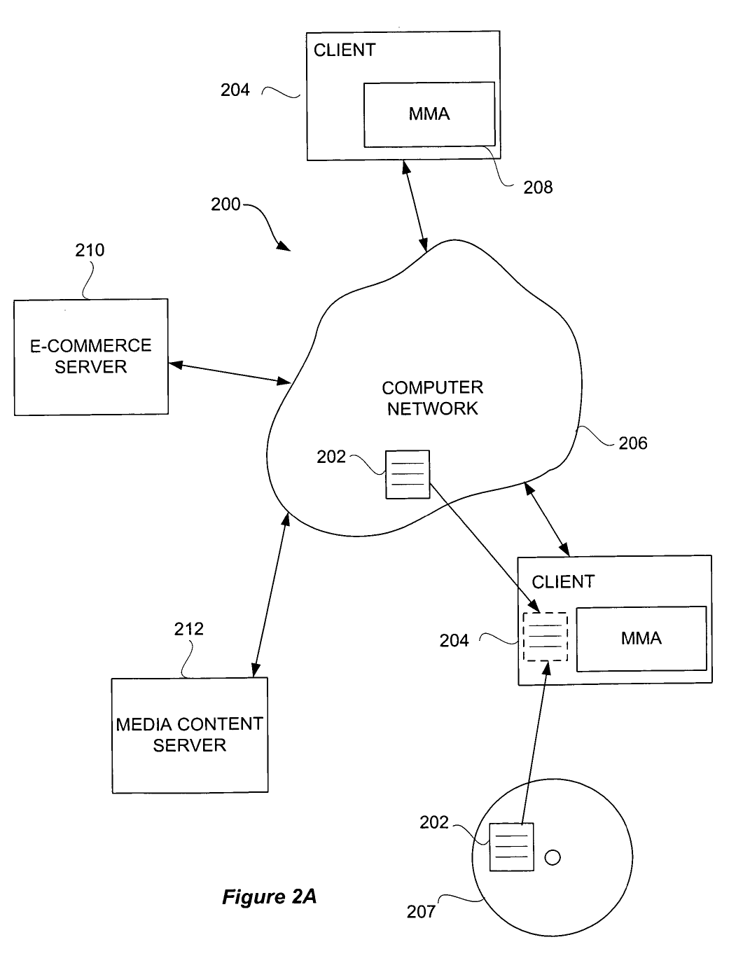

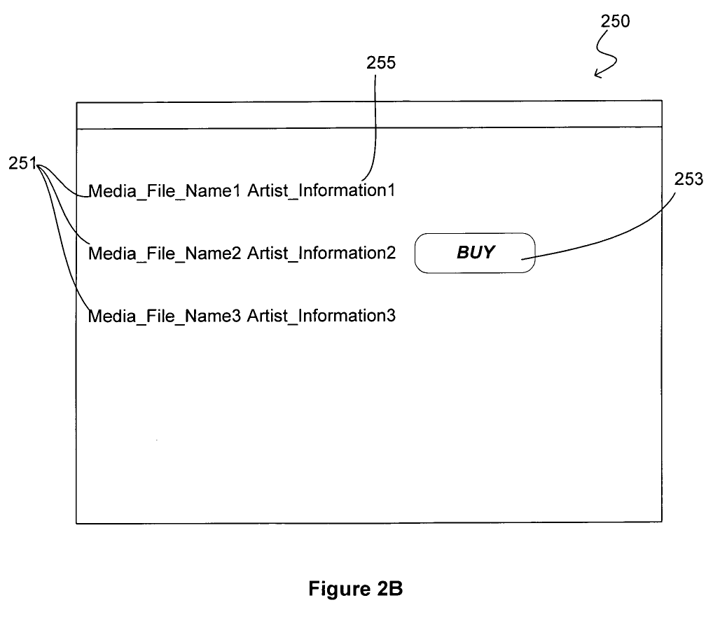

FIG. 2A is an e-commerce system 200 for media items according to one embodiment of the invention. A digital media file 202, including media content and embedded e-commerce information, is stored on a client computer 204. Digital media file 202 may be downloaded via a computer network 206 (such as the Internet), or copied from a CD-ROM, flash memory card, MiniDisc™, DVD-ROM or other portable digital data storage device 207. The embedded e-commerce information is accessed by using a media management application 208, which may display information, including digital media file indicators and, if applicable, e-commerce indicators (discussed below in reference to FIG. 2B.) If a user wants to use the subject matter of the embedded e-commerce information in some manner (e.g., to purchase a song or a concert ticket or to visit a web site), then a request is sent to a remote e-commerce server 210, which controls user authentication, payment processing, and, if applicable, on-line delivery of purchased media items or license keys. Remote media content server 212 delivers media items via computer network 206 to client computer 204 upon receiving delivery instructions from e-commerce server 210 (directly or via the MMA 208).

FIG. 2B is a diagram of a generic application window 250 according to one embodiment of the invention. The generic application window 250 is produced by a client application, for example, a media management application (MMA). An example of a representative media management application is iTunes™, produced by and available from Apple Computer, Inc. of Cupertino, Calif. Other media management application examples include RealNetworks Rhapsody™ Jukebox, WinAmp™, and MusicMatch Jukebox™. A media management application is typically a software application which is used to organize and play digital media files on a personal computer. Additionally, media management applications are sometimes used to organize digital media files on portable digital media players. Some of these MMAs, such as iTunes™, are also capable of directly accessing online media stores, enabling the user to browse and/or purchase digital media files.

As shown in FIG. 2B, one or more digital media file indicators 251 are listed (e.g., displayed) in the generic application window 250. The digital media file indicators 251 identify the associated digital media files. In one embodiment, such as shown in FIG. 2B, the digital media file indicators 251 can be names (e.g., digital media file names). In another embodiment, the digital media file indicators 251 can be images. If a digital media file being listed in the generic application window 250 has media attribute information 107, at least a portion of the media attribute information 107, such as artist information 255, can be displayed in a manner associated with the corresponding digital media file indicator 251. Additionally, if the digital media file has e-commerce information 113 within the e-commerce header segment 111, an e-commerce indicator 253 can be displayed. For example where the e-commerce information 113 is a link to purchase a media file, as shown in FIG. 2B, the e-commerce indicator can be implemented as a “buy” button displayed in a manner associated with the corresponding digital media file indicator 251. If the user of the client application wants to purchase the subject matter of the e-commerce information 113 corresponding to the digital media file designated by the digital media file indicator 251 (Media_File_Name_{—}2), the user can select the e-commerce indicator 253 to initiate the purchase.

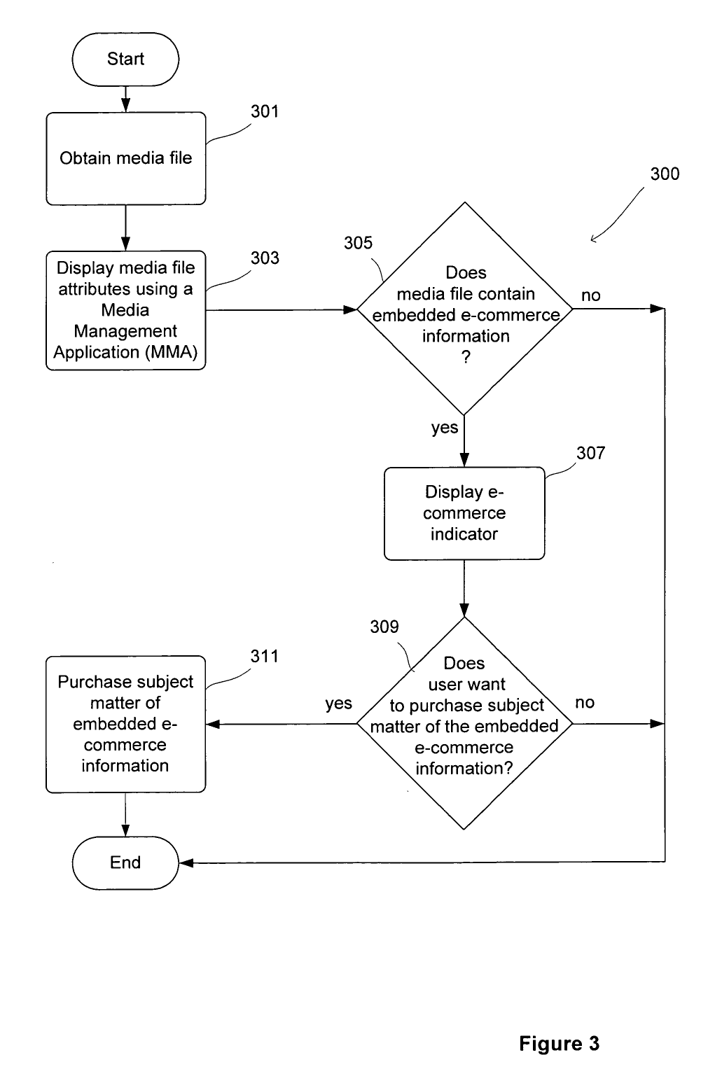

FIG. 3 is a flow diagram of a client-side process 300 for facilitating e-commerce according to one embodiment of the invention. The client-side process 300 can be performed using a client application, such as a media management application.

The client-side process 300 begins by obtaining 301 a digital media file. This obtaining 301 may be accomplished in any number of ways including, but not limited to, downloading via a computer network (such as the Internet), or copying from a CD-ROM, DVD-ROM or other portable digital data storage device. Next, digital media file attributes for the digital media file are displayed 303 in a client application window, such as that described in reference to FIG. 1.

A decision 305 then determines whether the digital media file contains embedded e-commerce information. When the decision 305 determines that no e-commerce information is detected in the digital media file, this client-side process 300 ends. If, on the other hand, the decision 305 determines that e-commerce information is embedded in the digital media file, then an e-commerce indicator is displayed 307. Typically, the e-commerce indicator is displayed 307 proximate to the information pertaining to the media item so that the user understands which digital media file the e-commerce indicator is associated with. Next, decision 309 determines whether or not the user of the client application wishes to use (e.g., purchase) the subject matter of the embedded e-commerce information. If not, client-side process 300 ends with no use being made. However, if decision 309 determines that the user wants to use the subject matter of the embedded e-commerce information, then client-side process 300 is directed to purchase 311 the subject matter of the embedded e-commerce information. Typically, the client application would interact with a remote e-commerce server to purchase 311 the subject matter of the embedded e-commerce information.

In general terms, the digital media file contains media content, and the subject matter of the e-commerce information is any product or service that can be the subject of commerce. For example, the media content can be a music video, while the subject matter of the embedded e-commerce information can be a music single. Or, the media content could be a partial music single, while the subject matter of the embedded e-commerce information could be a complete music single. Further, the subject matter of the embedded e-commerce information can be something other than a media content. Possible subject matter includes music CDs or DVDs, movie DVDs, event tickets (e.g., such as for concerts or sporting events related to the media file), electronic books, printed books, or other merchandise. The digital media file can be an advertisement for a product and the subject matter of the e-commerce information can be the product itself or the e-commerce information can simply be a link to aweb site where related material may be used and/or purchased.

Table 1 below provides these and further combinations of media content types and associated subject matter of the e-commerce information. Note that this table is meant to be exemplary, not comprehensive.

TABLE 1

| Digital media file Format | Subject Matter of e-Commerce Information |
|---|---|
| Music video | Music single |
| DRM locked music single | Unlocked music single |
| Music single (low quality) | Music single (high quality) |
| Music single | Different music single |
| Music single | Music album |
| Music single | Concert tickets |
| Partial music single | Complete music single |
| Music video | Music DVD or CD |
| Music single | Right to burn the music single to a CD |
| Music single | Right to play music single on multiple |
| | music players |
| Partial electronic book | Complete electronic book |
| Partial electronic book | Printed book |
| Video | Video soundtrack |

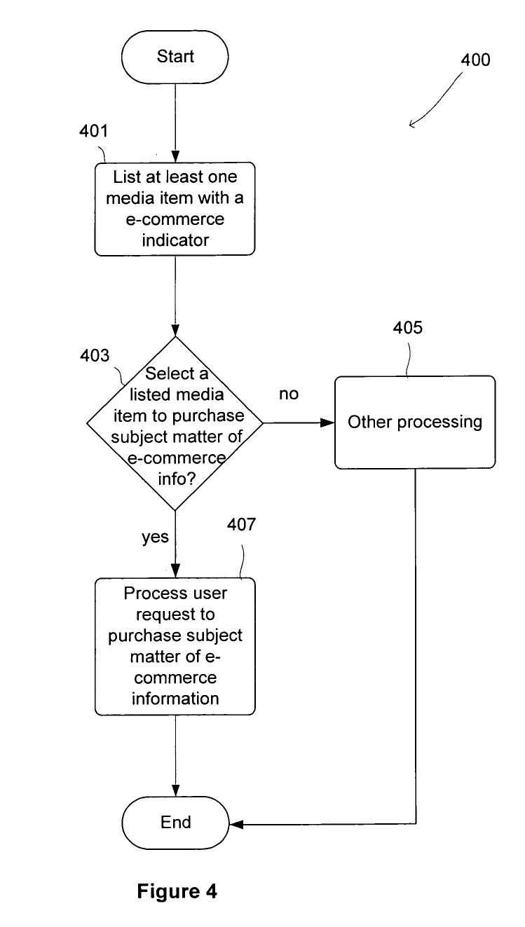

FIG. 4 is a flow diagram of a media item purchase process 400 according to one embodiment of the invention. The media item purchase process 400 can be performed by a client application. The media item purchase process 400 begins by listing 401 at least one media item with an e-commerce indicator. Typically, the at least one media item and the e-commerce indicator would be presented to a user as part of a graphical user interface. Next, decision 403 determines if a media item having associated e-commerce information, or its e-commerce indicator, has been selected. Here, the selection would normally be made by the user interacting with the graphical user interface. The selection, if made, serves as a user request to purchase the subject matter of the e-commerce information. When the decision 403 determines that a selection of a media item having associated e-commerce information has not been made, then the media item purchase process 400 continues with other processing 405 (which can include such conventional operations as viewing, playing, and copying of media) before ending. Alternately, when the decision 403 determines that a selection of a media item having associated e-commerce information, or its associated e-commerce indicator, has been made, then the user request to purchase the subject matter of the e-commerce information associated with the digital media file is processed 407. Thereafter, the media item purchase process 400 ends.

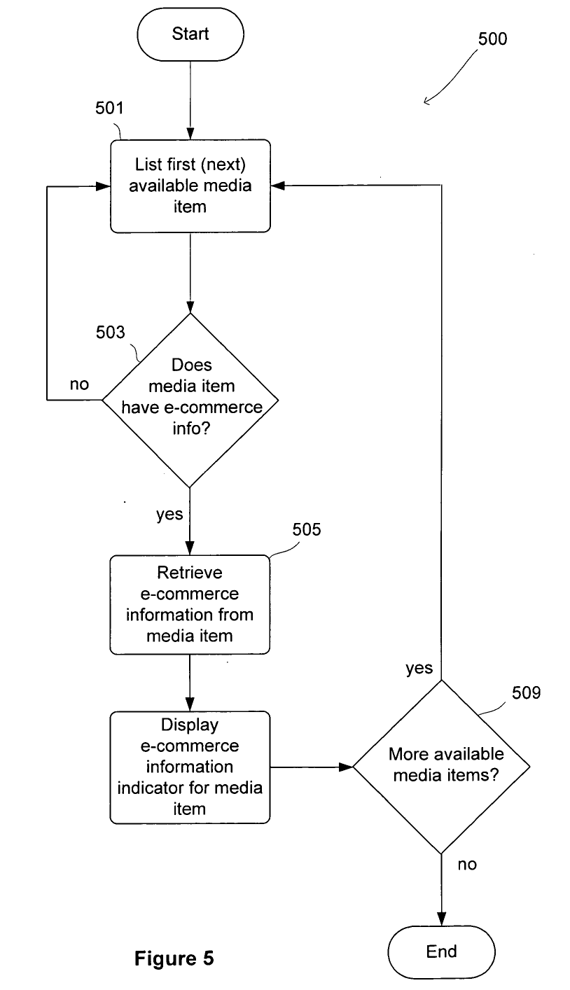

FIG. 5 is a flow diagram of a media item display process 500 according to one embodiment of the invention. The digital media file display process 500 is one embodiment of the operation 401 of the media item purchase process 400 described above with reference to FIG. 4.

The digital media file display process 500 begins by listing 501 (e.g., displaying) the first (or next) available media item (e.g., available digital media file). Typically, the media item is locally resident at the client application performing the media item display process 500. Next, a decision 503 examines (e.g., parses) a media item to determine whether the media item being listed has embedded e-commerce information. If the decision 503 determines that the media item being listed does not have embedded e-commerce information, the media file display process 500 returns to the operation 501 so that a next available media item can be listed 501. On the other hand, if the decision 503 determines that the media item being listed does have embedded e-commerce information, the e-commerce information is retrieved 505 from the digital media file. An e-commerce information indicator can then be displayed 507 proximate to the listed available media item. Next, a decision 509 determines whether there are more available media items. If the decision 509 determines that there are more available media items, the media item display process 500 repeats the operations 501-507 for a next one of the available media items. Once the decision 509 determines that there are no more available media items, the media item display process 500 is complete and ends.

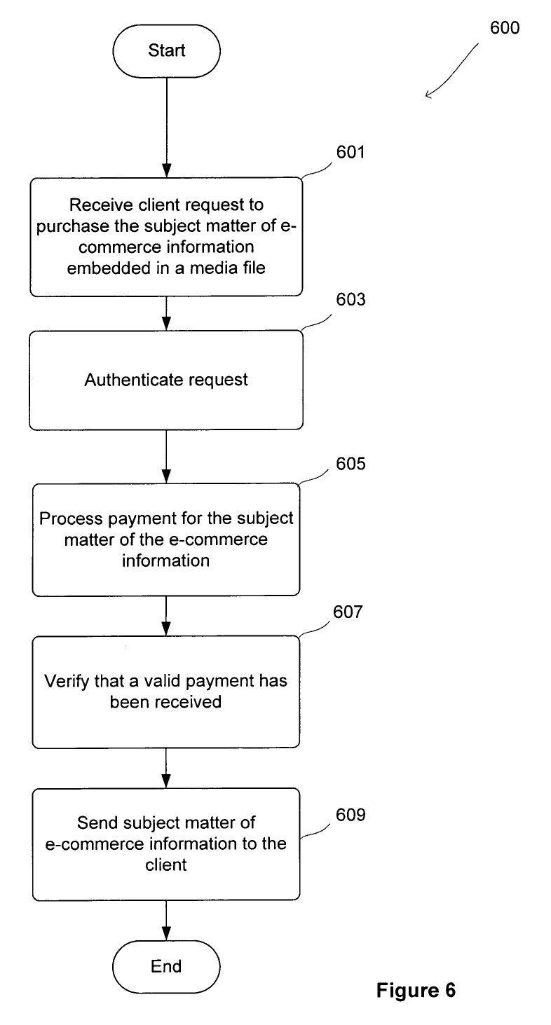

FIG. 6 is a flow diagram of a media purchase process 600 according to one embodiment of the invention. The media purchase process 600 is one embodiment of processing performed at a server machine (e.g., remote e-commerce server) in response to the operation 407 of the media item purchase process 400 described above with reference to FIG. 4.

The media purchase process 600 begins upon receiving 601 a client request to purchase the subject matter of e-commerce information embedded in a digital media file. The client request to purchase is then authenticated 603. Authentication may include entering a user identification and password. Upon successful authentication 603, a payment for the subject matter of the e-commerce information is processed 605. Next, the purchasing process 600 can verify 607 that a valid payment has been received. Finally, the subject matter of the e-commerce information is sent 609 to the requesting client (e.g., client application). Note that this sending 609 is not limited to electronic downloading of one or more digital media files. In some circumstances, such as the case where merchandise or event tickets are purchased, the sending 609 can pertain to other non-electronic forms of delivery, such as postal mail.

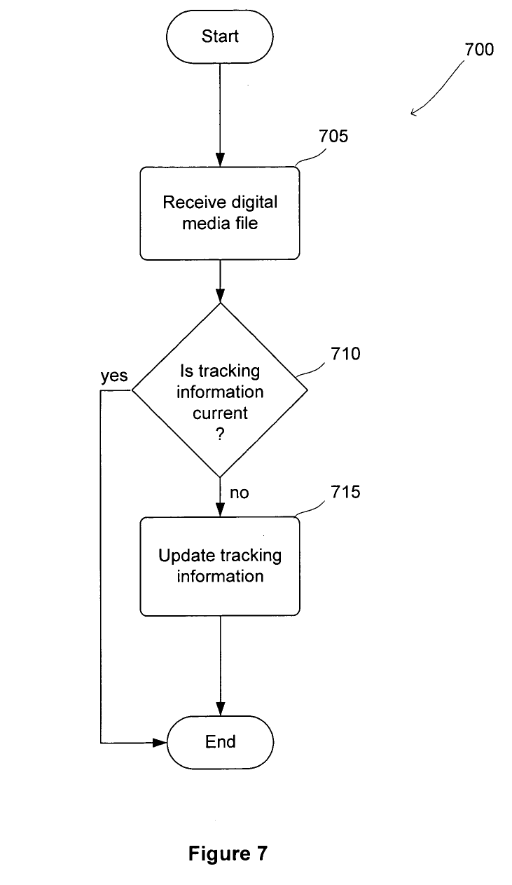

FIG. 7 is a flow diagram of a media tracking process 700 according to one embodiment of the invention.

The media tracking process 700 begins upon receipt 705 of a digital media file by a client computer. In this embodiment, and where consistent with privacy norms, the digital media file contains embedded tracking information, which may be in replacement or in addition to e-commerce information 115 (discussed above in reference to FIG. 1). Next, decision 710 determines if the tracking information embedded in the digital media file is current. If so, then the media tracking process 700 ends without altering the received digital media file. On the other hand, if the tracking information is not current, then the tracking information for the digital media file is updated 715. In this way, a record of the path that a particular media file has traversed is kept within the file. For privacy reasons, the tracking information may be encrypted. In one embodiment, tracking information is only updated if the digital media file has been played or used on a particular computer. Alternately, tracking information may be updated any time the digital media file has been stored on a particular computer. As an example, updating tracking information can involve making a record of a MAC or IP, address, or storing a user or computer name. At any point, tracking information can be extracted and examined by authorized persons or devices in order to determine where a file has been and who has played the file. In another embodiment, tracking information is placed in the media file to identify the original source of the file (e.g., the web site where the file was originally placed such that others could download it), and not thereafter updated. In this embodiment, for example, the tracking information can be used to identify from where a media file originated at the time a user purchases the subject matter of the e-commerce information as described above in FIG. 6.

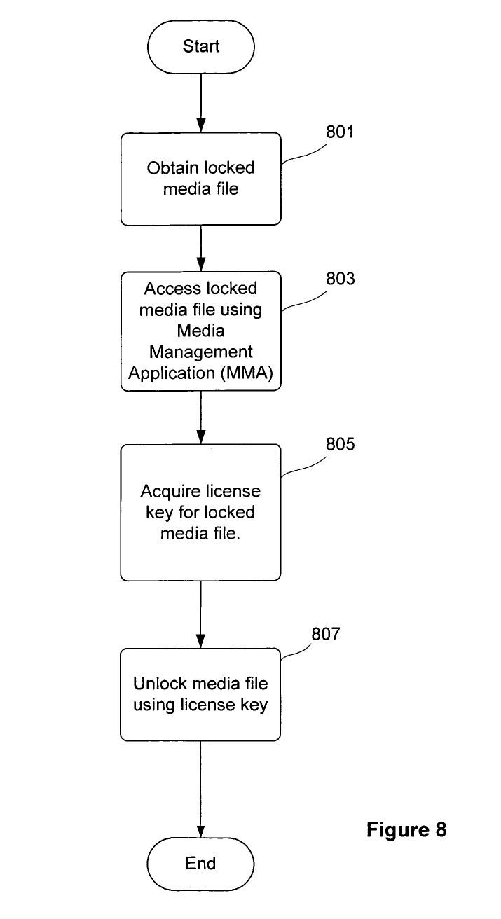

FIG. 8 is a flow diagram of a media unlocking process 800 according to one embodiment of the invention. The media unlocking process 800 begins with the obtaining 801 of a restricted (e.g., locked) digital media file, for example, a media file that is locked using a DRM scheme. In order to access the media content locked within the digital media file, the digital media file needs to be unlocked by obtaining a license key. Accordingly, in operation 803, the restricted digital media file is accessed using a MMA. Next, the MMA is used to acquire 805 (e.g., purchase) a license key for the restricted digital media file. Upon obtaining the appropriate license key, the digital media file can be unlocked 807. Once the digital media file is unlocked, the digital media file can be used (e.g., played) using the MMA or other authorized media player. The license or license key can permit full or unlimited use of the digital media file once unlocked, or can limit the authorized usage of the digital media file according to the terms of the license or license key.

The various aspects, features, embodiments or implementations of the invention described above can be used alone or in various combinations.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A digital media file, comprising:
media content; and
embedded e-commerce information which is usable by a media management application such that a subject matter of the embedded e-commerce information is purchasable using the media management application.

2. The digital media file of claim 1, further comprising:
embedded tracking data.

3. The digital media file of claim 1, wherein the subject matter of the embedded e-commerce information is a product or service associated with the media content.

4. The digital media file of claim 1, wherein the media content is locked.

5. The digital media file of claim 1, wherein the media content is selected from the group consisting of a partial music file, a locked music file, a low quality music file, a complete music file, a music video, a partial e-book, an audio advertisement, a video advertisement, and a movie preview.

6. The digital media file of claim 1, wherein the subject matter of the embedded e-commerce information is selected from the group consisting of an unlocked music file, a collection of music files, event tickets, a music DVD, a music CD, a complete e-book, and a printed book.

7. The digital media file of claim 1, wherein the subject matter of the embedded e-commerce information is selected from the group consisting of the right to play the digital media file on a media player or the right to copy the digital media file onto a removable storage media.

8. The digital media file of claim 1, further comprising embedded tracking information.

9. The digital media file of claim 1, wherein the subject matter of the e-commerce information is a license key to enable playback of the digital media file.

10. The digital media file of claim 1, wherein the subject matter of the embedded e-commerce information is rights to use the digital media file.

11. A method for facilitating e-commerce, comprising:
obtaining a digital media file, the digital media file including media content and embedded e-commerce information;
accessing the embedded e-commerce information of the digital media file using a media management application; and
using the media management application to purchase one or more rights relating to the digital media file according to the embedded e-commerce information of the digital media file.

12. The method of claim 11, wherein the one or more rights pertain to the right to play the digital media file on a media player or the right to copy the digital media file onto a removable storage media.

13. The method of claim 11, wherein the one or more rights are selected from the group consisting of the right to play the digital media file on a single media player, the right to play the digital media file on more than one media player, and the right to copy the digital media file onto removable storage media.

14. The method of claim 12, wherein the removable storage media is a selected from the group consisting of compact disk (CD), DVD, Minidisc™ and flash memory card.

15. The method of claim 11, wherein the digital media file is selected from the group consisting of a partial music file, a complete music file, a music video, a partial e-book, an audio advertisement, a video advertisement, and a movie preview.

16. A method for facilitating e-commerce, comprising:
obtaining a digital media file, the digital media file including media content and embedded e-commerce information;
accessing the embedded e-commerce information of the digital media file using a media management application; and
using the media management application to purchase the subject matter of the e-commerce information.

17. The method of claim 16, wherein the subject matter of the embedded e-commerce information is the digital media file.

18. The method of claim 16, wherein the subject matter of the embedded e-commerce information is one or more digital media files.

19. The method of claim 16, wherein the digital media file is a video file and the subject matter of the embedded e-commerce information is a music file.

20. The method of claim 16, wherein the digital media file is a partial music file and the subject matter of the embedded e-commerce information is one or more complete digital media files.

21. The method of claim 16, wherein the digital media file is a music file and the subject matter of the embedded e-commerce information is a music album.

22. The method of claim 16, wherein the subject matter of the embedded e-commerce information is an event ticket.

23. A method for facilitating e-commerce, comprising:
obtaining a digital media file, the digital media file including media content and embedded tracking information;
accessing the embedded tracking information using a media management application; and
reporting the embedded tracking information.

24. The method of claim 23, wherein the reporting occurs upon purchase of the digital media file.

25. The method of claim 23, wherein the digital media file further includes embedded e-commerce information.

26. The method of claim 23, wherein the subject matter of the embedded e-commerce information is the digital media file.

27. The method of claim 26, wherein the digital media file comprises media content and the subject matter of the embedded e-commerce information is one or more digital media files.

28. The method of claim 26, wherein the digital media file is a partial music file and the subject matter of the embedded e-commerce information is a complete music file.

29. The method of claim 26, wherein the digital media file is a music file and the subject matter of the embedded e-commerce information is a music album.

30. The method of claim 26, wherein the digital media file is a music video file and the subject matter of the embedded e-commerce information is a music file.

31. The method of claim 26, wherein the digital media file comprises media content and the subject matter of the embedded e-commerce information is an event ticket.

32. A method for facilitating e-commerce, comprising:
receiving a client request to purchase the subject matter of e-commerce information embedded in a digital media file,
authenticating the client request;
processing a payment for the subject matter of the e-commerce information;
verifying that the payment for the subject matter of the e-commerce information has been received; and
sending the subject matter of the e-commerce information to the requesting client.

33. The method of claim 32, wherein the subject matter of the e-commerce information is a license key to enable playback of the digital media file.

34. The method of claim 33, wherein the license key further enables the copying of the digital media file to a removable storage media.

35. The method of claim 33, wherein the license key enables the playing of the media on one or more additional media players.

36. The method of claim 32, wherein the subject matter of the e-commerce information is digital media file.

37. The method of claim 32, wherein the subject matter of the e-commerce information is a music file, music video, or e-book.

38. The method of claim 32, wherein the subject matter of the e-commerce information is a link to obtain event admission tickets.

39. A method for facilitating e-commerce, comprising:
parsing a set of digital media files for embedded e-commerce information using a media management application;
displaying the set of digital media files in a media management application window, wherein each digital media file having embedded e-commerce information is displayed with an e-commerce indicator;
determining whether the e-commerce indicator being displayed is selected; and
initiating purchase of the subject matter of the embedded e-commerce information associated with a digital media file when said determining determines that the e-commerce indicator has been selected.

40. A method for facilitating e-commerce, comprising:
obtaining a digital media file, the digital media file including media content and embedded e-commerce information;
accessing the embedded e-commerce information of the digital media file using a media management application;
receiving a user request to purchase one or more rights relating to the digital media file;
connecting to a remote commerce server via a network;
authenticating the user request to purchase;
processing a payment for the rights relating to the digital media file; and
granting a license to the rights relating to the digital media file.

41. The method of claim 40, wherein the first, second, and third remote commerce servers are the same server computer.

42. A computer system for facilitating e-commerce, comprising:
one or more client computers, each connected to a computer network;
a client media management application running on one or more of the client computers;
at least one digital media file including media content and embedded e-commerce information stored on a client computer connected to the computer network and running the client media management application;
one or more remote server computers configured to process e-commerce transactions using at least the embedded e-commerce information, each remote server computer connected to the computer network; and
one or more remote media content server computers configured to deliver media content to any client computer connected to the computer network upon the successful completion of an e-commerce transaction.

43. A computer readable medium including at least one digital media file, the digital media file comprising media content, and embedded e-commerce information which is usable by a media management application such that a subject matter of the embedded e-commerce information is accessible from the media management application.

44. A computer readable medium as recited in claim 43, wherein the embedded e-commerce information is purchasable using the media management application.

45. A computer readable medium as recited in claim 43, wherein the digital media file further comprises embedded tracking information.

46. A computer readable medium as recited in claim 43, wherein the media content is locked.

47. A computer readable medium as recited in claim 43, wherein the media content is selected from the group consisting of a partial music file, a locked music file, a low quality music file, a complete music file, a music video, a partial e-book, an audio advertisement, a video advertisement, and a movie preview.
